(19) United States
(12) Patent Application Publication
(10) Pub. No.: US 2022/0400398 A1
(43) Pub. Date: Dec. 15, 2022

(54) VEHICLE CONNECTIVITY AND COMMUNICATION DEVICE

(71) Applicant: AVEOPT, INC., Rochester, MI (US)

(72) Inventor: Arthur Kahn, Northbrook, IL (US)

(21) Appl. No.: 17/890,034

(22) Filed: Aug. 17, 2022

Related U.S. Application Data
(63) Continuation-in-part of application No. 16/933,611, filed on Jul. 20, 2020, now abandoned.
Application No. 16/933,611 is a continuation-in-part of application No. 16/707,682, filed on Dec. 9, 2019, now Pat. No. 11,288,970.
(60) Provisional application No. 62/808,496, filed on Feb. 21, 2019.

(51) Int. Cl. H04W 24/08; H04Q 9/00; G08G 1/16; H04W 72/08

(52) U.S. Cl. CPC H04W 24/08; H04Q 9/00; G08G 1/161; H04W 72/085

(57) ABSTRACT

A vehicle connectivity and communication device includes at least one transmitter/receiver for establishing and maintaining communications with a system for controlling and/or monitoring vehicles and/or traffic over at least two different communications infrastructures, at least one sensor for measuring and reporting a performance characteristic of communication over the different communications infrastructures, and a controller for selecting an active communications infrastructure based on the measured performance characteristic.

### CROSS-REFERENCE TO RELATED APPLICATIONS

This application is a Continuation-in-Part of application Ser. No. 16/933,611, filed on Jul. 20, 2020, which claims priority to a Continuation-in-Part of application Ser. No. 16/707,682, filed on Dec. 9, 2019, which claims priority to U.S. Provisional Application No. 62/808,496, filed on Feb. 21, 2019 and which are hereby incorporated by reference in their entireties.

### FIELD OF THE DISCLOSURE

This application pertains to traffic management systems, including sea, ground, and aerial traffic management for unmanned and autonomous aerial, ground or maritime vehicles, and more particularly to a subsystem for selecting a communication infrastructure for monitoring, and/or controlling vehicles using a traffic management system, and/or for communications between or among managed vehicles and between managed vehicles and the traffic management system.

### BACKGROUND OF THE DISCLOSURE

The rapid proliferation of unmanned aircraft systems (UAS's) necessitates systems and methods suitable for the integration of such systems into shared airspace. One of the most critical challenges associated with integration of small UAS's into shared airspace is effective unmanned traffic management (UTM). Currently, there are many limitations in the infrastructure used to enable and safely manage the widespread use of UAS's, regardless of the type of UAS. The size and altitude of many UAS's are such that traditional air traffic control systems, such as surveillance radar, are inappropriate. Radar technologies have difficulties monitoring UAS traffic at low altitudes, particularly when there are obstructions. As a result, other types of infrastructure networks, such as wireless and SATCOM, are used with radar to ensure appropriate levels of coverage.

Conventional UTM systems, such as flight plans, address vehicle tracking via flight plans, Internet of Things input, etc. However, these solutions are dependent upon the wireless infrastructure network for operation, which presents limitations. First, the wireless infrastructure network may be often deficient in its effectiveness in supporting normal use due to geographic and terrain issues, inability to meet current and growing capacity needs, weather conditions, etc. We all have experienced loss of signal for various reasons. Wireless infrastructure alone may be not adequate to enable tracking of huge populations of UAS's that will be in operation. This results in a loss of signal and degradation of performance as UAS's move from one location through another.

Consequently, there is a need for a reliable and effective solution for monitoring and arbitrating the performance of UTM infrastructure systems.

### SUMMARY OF DISCLOSURE

Disclosed, among other things, is a vehicle connectivity and communication unit for monitoring performance characteristics of a plurality of communications infrastructures, and selecting a particular communications infrastructure for communication between a vehicle and a traffic management system based on measured performance characteristics and criteria for selecting an active communications infrastructure that is used for monitoring and/or controlling the vehicle, and/or for communication with another vehicle via another vehicle connectivity and communication unit.

The vehicle connectivity and communication device includes a transmitter/receiver, at least one sensor for measuring and reporting communications infrastructure performance, and a controller for selecting the active communications infrastructure used for monitoring and/or controlling the vehicle, and/or for communicating with other vehicles.

In one embodiment disclosed herein, a vehicle connectivity and communication device includes at least one transceiver configured to selectively communicate with at least two different communication infrastructures from the group of a wireless cellular communication infrastructure, a radio frequency communication infrastructure, and a satellite communication infrastructure, at least one sensor configured to measure a performance characteristic of each of the selected communication infrastructures and to generate a signal indicative of the measured performance characteristic for each respective selected communication infrastructures, and a controller in communication with the at least one transceiver and the at least one sensor configured to select at least one of the at least two different communication infrastructures and deselect the other of the at least two difference communication infrastructures based on the signal indicative of the measured performance character for each of the respective selected communication infrastructures.

In another embodiment disclosed herein, a vehicle connectivity and communication device includes at least one transceiver configured to selectively communicate with at least two different communication infrastructures having different communication protocols and selected from the group of a land-based communication infrastructure, an aerial-based communication infrastructure and a space-based communication infrastructure, at least one sensor configured to measure a performance characteristic of each of the selected communication infrastructures and to generate a signal indicative of the measured performance characteristic for each respective selected communication infrastructures, and a controller in communication with the at least one transceiver and the at least one sensor configured to select at least one of the at least two different communication infrastructures and deselect the other of the at least two difference communication infrastructures based on the signal indicative of the measured performance character for each of the respective selected communication infrastructures.

In another embodiment disclosed herein, a vehicle connectivity and communication device including at least one transceiver configured to selectively communicate with at least two different communication infrastructures having different communication protocols, at least one sensor configured to measure a performance characteristic of each of the selected communication infrastructures and to generate a signal indicative of at least one of a strength of signal value, a calculated communication latency value, and an observed communication signal continuity value for each respective selected communication infrastructures, and a controller in communication with the at least one transceiver and the at least one sensor configured to select at least one of the at least two different communication infrastructures and deselect the other of the at least two difference communication infrastructures based on the signal indicative of the measured performance character for each of the respective selected communication infrastructures.

### BRIEF DESCRIPTION OF THE SEVERAL VIEWS OF THE DRAWING

The above, as well as other advantages of the present disclosure, will become readily apparent to those skilled in the art from the following detailed description when considered in light of the accompanying drawings in which:

FIG. 1 illustrates a schematic view of an exemplary system for monitoring and arbitrating UTM infrastructure networks;

FIG. 2 is a flowchart of an exemplary method for monitoring and arbitrating UTM infrastructure networks using the system of FIG. 1;

FIG. 3 is a schematic view of another exemplary system for monitoring and arbitrating UTM infrastructure networks;

FIG. 4 illustrates a schematic view of another exemplary system for monitoring and arbitrating UTM infrastructure networks similar to FIG. 1;

FIG. 5 illustrates an operational schematic diagram of a Vehicle Connectivity Unit (VCU) in communication with a plurality of communication infrastructures;

FIG. 6 illustrates an alternative operational schematic diagram of a VCU in communication with a plurality of communication infrastructures;

FIG. 7 illustrates an additional alternative operational schematic diagram of a VCU in communication with a plurality of communication infrastructures; and

FIG. 8 illustrates an operational schematic diagram of a vehicular-based VCU in communication with a plurality of stationary VCUs enabling a Communications Infrastructure Mesh (CIM) to relay vehicular-based VCU communications along a vehicle travel path while maintaining communication with the Traffic Management System and Arbitration System controller.

### DETAILED DESCRIPTION

It is to be understood that the invention may assume various alternative orientations and step sequences, except where expressly specified to the contrary. It may be also understood that the specific devices and processes illustrated in the attached drawings and described in the specification are simply exemplary embodiments of the inventive concepts disclosed and defined herein. Hence, specific dimensions, directions or other physical characteristics relating to the various embodiments disclosed are not to be considered as limiting, unless expressly stated otherwise.

In the following detailed description, numerous specific details are set forth in order to provide a thorough understanding of the examples as defined in the claimed subject matter, and as an example of how to make and use the examples described herein. However, it will be understood by those skilled in the art that claimed subject matter may be not intended to be limited to such specific details and may even be practiced without requiring such specific details. In other instances, well-known methods, procedures, and ingredients have not been described in detail so as not to obscure the invention defined by the claimed subject matter. Some portions of the detailed description that follow are presented in terms of algorithms and/or symbolic representations of operations on data bits and/or binary digital signals stored within a computing system, such as within a computer and/or computing system memory. An algorithm is here and generally considered to be a self-consistent sequence of operations and/or similar processing leading to a desired result. The operations and/or processing may take the form of electrical and/or magnetic signals configured to be stored, transferred, combined, compared and/or otherwise manipulated. It has proven convenient at times, principally for reasons of common usage, to refer to these signals as bits, data, values, elements, symbols, characters, terms, numbers, numerals and/or the like. It should be understood, however, that all of these and similar terms are to be associated with appropriate physical quantities and are merely convenient labels. Unless specifically stated otherwise, as apparent from the following discussion, it may be appreciated that throughout this specification discussions utilizing terms such as “processing”, “computing”, “calculating”, “determining” and/or the like refer to the actions and/or processes of a computing platform, such as a computer or a similar electronic computing device that manipulates and/or transforms data represented as physical electronic and/or magnetic quantities and/or other physical quantities within the computing platform's processors, memories, registers, and/or other information storage, transmission, and/or display devices.

Unless specifically stated otherwise, as apparent from the following discussion, it may be appreciated that throughout this specification a computing platform includes, but may be not limited to, a device such as a computer or a similar electronic computing device that manipulates and/or transforms data represented by physical, electronic, and/or magnetic quantities and/or other physical quantities within the computing platform's processors, memories, registers, and/or other information storage, transmission, reception and/or display devices. Accordingly, a computing platform refers to a system, a device, and/or a logical construct that includes the ability to process and/or store data in the form of signals. Thus, a computing platform, in this context, may comprise hardware, software, firmware and/or any combination thereof. Where it is described that a user instructs a computing platform to perform a certain action, it is understood that “instructs” may mean to direct or cause to perform a task as a result of a selection or action by a user. A user may, for example, instruct a computing platform embark upon a course of action via an indication of a selection, including, for example, pushing a key, clicking a mouse, maneuvering a pointer, touching a touch pad, touching a touch screen, acting out touch screen gesturing movements, maneuvering an electronic pen device over a screen, verbalizing voice commands, and/or by audible sounds. A user may include an end-user.

Flowcharts, also referred to as flow diagrams by some, are used in some figures herein to illustrate certain aspects of some examples. Logic they illustrate is not intended to be exhaustive of any, all, or even most possibilities. Their purpose is to help facilitate an understanding of this disclosure with regard to the particular matters disclosed herein. To this end, many well-known techniques and design choices are not repeated herein so as not to obscure the teachings of this disclosure.

Throughout this specification, the term “system” may, depending at least in part upon the particular context, be understood to include any method, process, apparatus, and/or other patentable subject matter that implements the subject matter disclosed herein. The subject matter described herein may be implemented in software, in combination with hardware and/or firmware. For example, the subject matter described herein may be implemented in software executed by a hardware processor.

Provided herein are methods and systems that enable reliable and effective monitoring, tracking, and arbitrating UTM infrastructure systems via a UTM arbitration system (UPAS) for UAS's. The UTM arbitration system may provide one or more services such as monitoring and managing connectivity between unmanned aerial vehicles (UAV's) and UTM infrastructure systems for various purposes, such as tracking the positioning of the U AV relative to its location (e.g., latitude, longitude, elevation) and the location of other unmanned aerial vehicles; monitoring UTM infrastructure systems (e.g., wireless, radar, satellite), such as UTM flight plan management systems, for any differences/discrepancies between various UTM infrastructure systems and for performance levels and performance degradation of the UTM infrastructure systems. The UPAS way also switch from using a primary UTM infrastructure system to using a secondary/backup UTM infrastructure system in response to the measured performance levels of the UTM infrastructure systems.

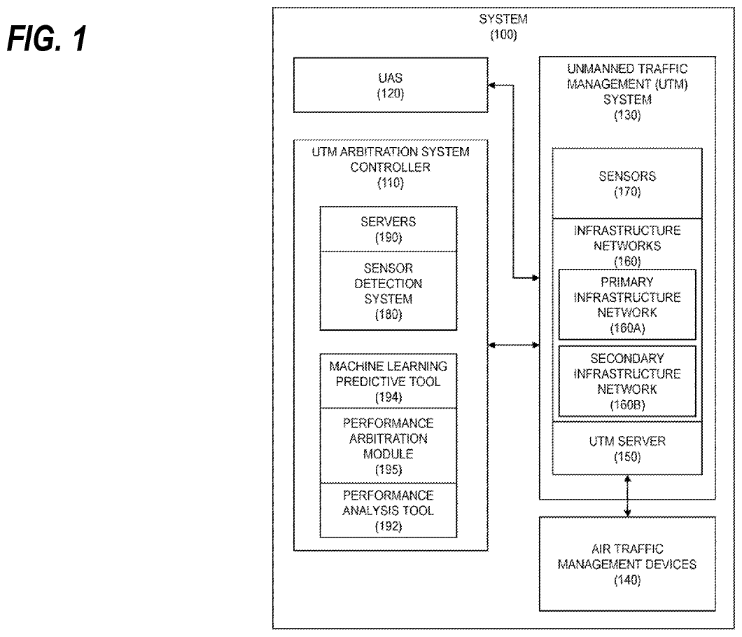

Referring to FIG. 1, FIG. 1 shows a schematic view of an exemplary system 100 for monitoring and arbitrating UTM infrastructure networks. The system 100 includes a UTM arbitration system 110, one or more UAS's 120, a UTM system 130, and one or more infrastructure networks 160. The UTM arbitration system 110 includes one or more UP AS servers 190. The one or more UP AS servers 190 may be computing devices, such as, but not limited to computer, a tablet, a desktop, a laptop, a smartphone, a watch, or other device capable of communicating with the UP AS server 190.

In an embodiment, the UTM arbitration system 110 also includes a sensor detection system 180 operably configured to detect one or more sensors 170 positioned on one or more infrastructure networks 160.

As best shown in FIG. 1 and as a non-limiting example, the UTM arbitration system 110 also includes a performance analysis tool 192 and a machine learning predictive tool 194, which may be operably configured to build a library of infrastructure performance against recorded conditions (i.e., weather, time of day, geographic/terrain conditions, etc.) and subsequently use that information as part of its analytics functionality supporting assessment and arbitration. The performance analysis tool 192 may be operably configured to monitor the performance of the one or more infrastructure networks 160.

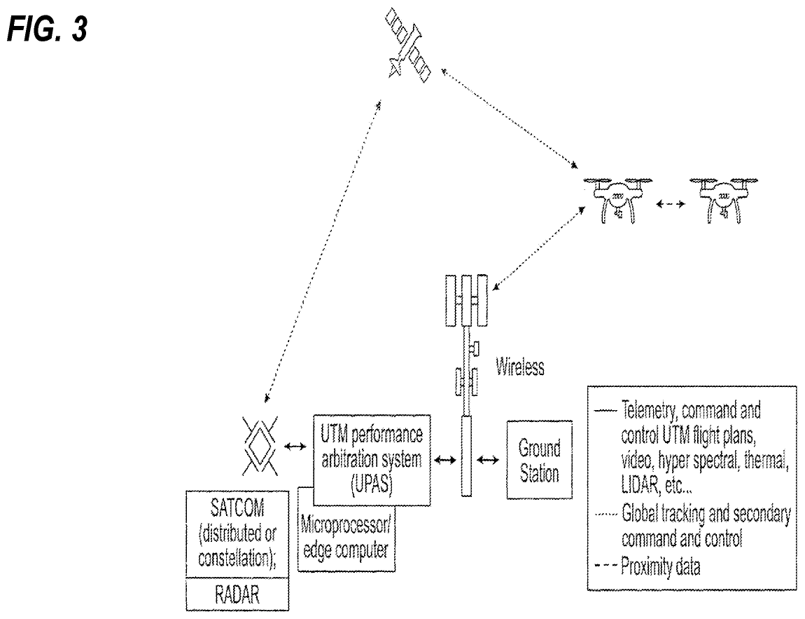

The UTM system 130 may be any known UTM system and may include one or more UTM servers 150 in communication with the one or more UAS's 120 via the one or more infrastructure networks 160. The one or more UTM servers 150 may be a computing device, such as, but not limited to computer, a tablet, a desktop, a laptop, a smartphone, a watch, or other device capable of communicating with the UTM server 150. In an embodiment, the one or more sensors 170 may be integrated within the one or more infrastructure networks 160. As best shown in FIGS. 1 and 3, in some embodiments, the one or more infrastructure networks 160 may be a radar infrastructure network, a satellite communication (SATCOM) infrastructure network, a wireless network (e.g., cellular telephone network, the Internet or a local area network), and/or any combination thereof. Non-limiting examples of the SATCOM infrastructure network are a distributed SATCOM infrastructure network and a constellation SATCOM infrastructure network. In yet other embodiments, other forms of communications may be used such as wired and wireless telecommunication channels.

As best shown in FIGS. 1 and 3, the one or more UTM servers 150 may communicate with one or more air traffic management devices 140, such as ground control, via the infrastructure networks 160. The one or more UTM servers 150 of the UTM system 130 may be configured to authorize a flight, coordinate the flight continuously throughout the flight, enable real-time communication with the one or more air traffic management devices 140, and maintain a database of active UAS's 120.

The one or more UAS's 120 may comprise any unmanned vehicle purposed for flight, including for example, UAV's, unmanned aircraft devices, and small unmanned aircraft systems (Susa's). The UTM system 130 may be configured to receive data from the one or more UAS's 120. In non-limiting examples, the data may be flight data and/or position data, such as current position, speed, and the like. Non-limiting examples of the flight data may be data related to an anticipated flight of the UAS 120, a flight purpose, a current location, a flight path/pattern, a flight area, a flight time, a flight duration, and/or combinations thereof

The one or more infrastructure networks 160 may either be one or more primary infrastructure networks 160A or one or more secondary infrastructure networks 160B in the UTM system 130. The one or more primary infrastructure networks 160A refer to the main/original infrastructure networks configured to manage the uses of the one or more UAS's 120. The one or more secondary infrastructure networks 160B refer to the backup infrastructure networks configured to manage the uses of the one or more UAS's 120 under specific circumstances.

In an embodiment, the UTM arbitration system 110 communicates, with the one or more infrastructure networks 160, via the one or more sensors 170. The UTM arbitration system 110 may be operably configured to monitor the performance of the one or more infrastructure networks 160. The one or more infrastructure networks 160 may be monitored simultaneously and in real-time.

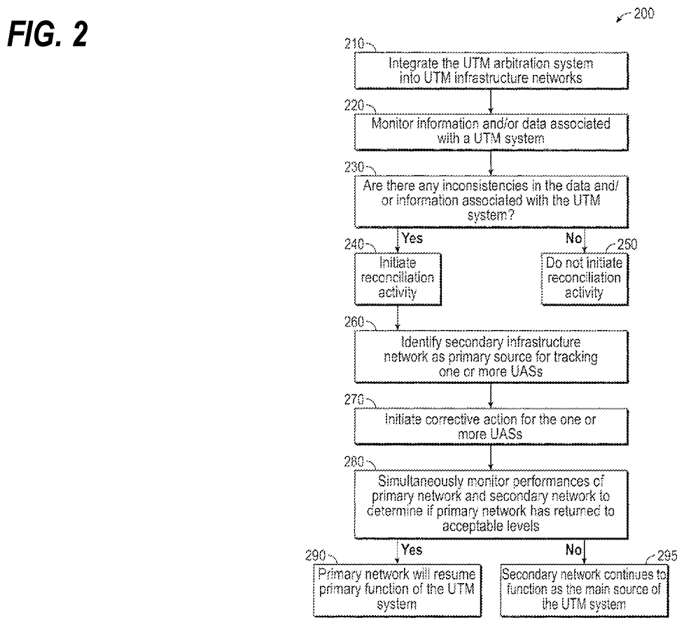

Referring to FIG. 2, FIG. 2 shows a flowchart of an exemplary method 200 for monitoring and arbitrating UTM infrastructure networks. As shown in block 210, the method 200 begins when the UTM arbitration system 110 integrates with each of the one or more infrastructure networks 160 of the UTM system 130 to enable simultaneous monitoring of the one or more infrastructure networks 160. In a non-limiting example, the one or more infrastructure networks 160 are the wireless infrastructure network and one of the SATCOM infrastructure network or the radar infrastructure network, which may be known as a hybrid infrastructure network.

In an embodiment, integration of the UTM arbitration system 110 into one or more of the infrastructure networks 160 involves physically housing the UTM arbitration system 110 in one or more of the infrastructure networks 160. Also, one or more API's in the infrastructure network 160 and in external systems, such as those available via the Internet, may be used in the system 100 to allow for integration between the UTM arbitration system 110 and the infrastructure network 160, such as a hybrid infrastructure network.

In an embodiment, the UTM arbitration system 110 integrates with external systems via the primary infrastructure network 160A to enable monitoring of various parameters in the UTM system 130, including but not limited to flight plans, vehicle identification, and/or vehicle-to-vehicle proximity tracking. Non-limiting examples of the external systems are asset management software, Internet of things, and weather updates.

Once the UTM arbitration system 110 has integrated with the one or more infrastructure networks 160, the UTM arbitration system 110 monitors information and/or data associated with the UTM system 130, as shown in block 220. The one or more UP AS servers 190 process and analyze this information and/or data in real-time using algorithms, such as analytical and machine learning algorithms, in order to determine if there are any inconsistencies across different components of the UTM system 130. This may be done to assess the performance of the one or more infrastructure networks 160. In some embodiments, some of the components analyzed in the UTM system 130 are flights plans versus physical vehicle tracking/positioning, versus vehicle-to-vehicle connectivity, versus weather conditions reports and forecasts. A non-limiting example of such a component may be a notification of change in a flight plan that would account for differences in plan versus vehicle tracking.

With regard to the one or more infrastructure networks 160, the one or more UPAS servers 190 analyze data and/or information associated with the primary infrastructure network 160A as compared with data and/or information associated with the secondary infrastructure network 160B. This may include monitoring the continuity of the signal, the coverage, and any latency issues related to the one or more infrastructure networks 160. In a non-limiting example, the UTM arbitration system 110 may have an integration protocol to monitor the state of integration with the one or more infrastructure networks 160.

As shown in block 230, the UTM arbitration system 110 determines whether there are inconsistencies in the data and/or information between information sources, other than between the primary infrastructure network 160A and the secondary infrastructure network 160B. If there are one or more inconsistencies, the UTM arbitration system 110 initiates a reconciliation activity, as shown in block 240. In an embodiment, the reconciliation activity may be defined based upon weighting and probability modeling applied against data and/or information acquired and processed from various disparate sources. While the reconciliation activities are occurring, the primary tracking functions for the UTM system 130 may be transferred from the primary infrastructure network 160A to the secondary infrastructure network 160B.

If the UTM arbitration system 110 does not find any inconsistencies in the data and/or information between information sources, the UTM arbitration system 110 will not initiate reconciliation activity, as shown in block 250.

If the UTM arbitration system 110 determines that the inconsistencies in the data/information emanate from the primary infrastructure network 160A, the UTM arbitration system 110 identifies the secondary infrastructure networks 160B as the primary source for tracking the one or more UAS's 120, as shown in block 260. The inconsistencies in the primary infrastructure network 160A may originate from the degradation of the primary infrastructure network 160A beyond predetermined acceptable levels or from interruptions in the performance of the primary infrastructure network 160A. In a non-limiting example, the wireless infrastructure network may be the original primary network 160A and the SATCOM and radar networks are the original secondary infrastructure networks 160B. Some of the data and/or information analyzed by the one or more UP AS servers 190 of the UTM arbitration system 110 when deciding whether to transition to a secondary/backup infrastructure network are associated with the positioning of the one or more UAS's 120 in the environment, vehicle proximity monitoring (i.e., collision avoidance), and the capacity of the wireless network.

Non-limiting examples of tracking performance of the UTM system 130 through positioning discrepancies include the following:
Primary infrastructure network 160A (i.e. wireless network) versus the original secondary infrastructure networks 160B (i.e., SATCOM or radar networks) by comparing tracking/positioning data to data from sources;
The one or more infrastructure networks 160 versus the Internet of Things based on filed flight plans in the UTM system 130 from secondary sources;
The one or more UAS's 120 versus the one or more infrastructure networks 160 versus the Internet of Things based on data from other sources; and
Vehicle versus vehicle proximity position.

In an embodiment, if the UTM arbitration system 110 identifies inconsistencies in the data and/or information between the primary network 160A and the secondary network 160B of the UTM system 130, the UTM arbitration system 110 may initiate a corrective action, such as a flight holding pattern for the one or more UAS's 120 in the environment, as shown in block 270. The flight holding pattern may be executed through integration between the flight control of the one or more UAS's 120 and the UTM arbitration system 110. The flight holding pattern may then be maintained until the discrepancies are reconciled and appropriate corrective action may be taken.

The UTM arbitration system 110, via the performance analysis tool 192, may then simultaneously monitor performances of the original primary network 160A and the secondary network 160B of the UTM system 130 to determine whether it may be safe for the UTM system 130 to return primary function to the primary network 160A, as shown in block 280. In an embodiment, if the UTM arbitration system 110 determines that the performance of the primary network 160A has returned to predetermined acceptable levels for a predetermined amount of time and that the performance degradation of the primary network 160A was the result of external forces, such as weather, the primary network 160A will resume primary function of the UTM system 130, as shown in block 290.

In an embodiment, if the UTM arbitration system 110 determines that the performance of the primary network 160A has not returned to predetermined acceptable levels for a predetermined amount of time or that the performance degradation of the primary network 160A was not the result of external forces, the secondary network 160B will continue to function as the main source for the UTM system 130, as shown in block 295.

Depending on the type and amount of discrepancies identified by the UTM arbitration system 110, non-limiting examples of corrective action may include the following:

Switching from the primary infrastructure network 160A (i.e., wireless network) versus the original secondary infrastructure networks 160B (i.e., SATCOM or radar networks) based on performance of the primary infrastructure network 160A, with the ability to switch back to the primary infrastructure network 160A upon performance improvement;
Modifying flight plans in the UTM system 130 based on discrepancies and/or needed flight corrections and results; and
Disabling or modifying vehicle-to-vehicle collision avoidance to extend the distance between vehicles relative to the action avoidance being required.

In some examples, arbitration using the UTM arbitration system 110 between discrepant sources of data may be first based on consistent data across a majority of data sources. In the event that there may be no majority among data sources, discrepancy reconciliation may be determined based upon the following, listed from most important:
Analytics performed against specific data sets with consideration given to various variables including but not limited to weighting factors for the data, probability algorithms, etc.;
V2X; refers to vehicle connectivity in the context of the Internet or as is referred to in the connectivity industry “Vehicle to Everything.” This would include external sources of information/data acquired from the Internet such as weather conditions, power outages (rolling or otherwise), Asset Management Systems relative to the infrastructure (scheduled and unscheduled maintenance, etc.;
The one or more infrastructure networks 160; and
Vehicle-to-vehicle proximity positioning.

In certain embodiments, the system 100 has a sensor detection system 180 that includes a sensor subsystem comprising a plurality of sensors 170 for determining signal performance between an unmanned aerial vehicle (UAV) and a wireless communication infrastructure (e.g., cellular telephone infrastructure) and between the UAV and a satellite communications infrastructure. System 100 also includes a controller or UTM arbitration system 110 having a computing device (e.g., performance analysis tool 192) that receives signals from the sensor subsystem, and a performance arbitration module 195 for switching between tracking and communicating with the unmanned aerial vehicle using wireless infrastructure or satellite communications infrastructure depending on relative performance criteria for the communications infrastructure. The sensor subsystem may include a plurality of signal strength meters, signal latency detection calculators, and/or other sensors or modules for characterizing signal performance. The controller 110 may be configured to switch tracking of (and/or communication with) the UAV from either communication infrastructure to the other when a loss of connectivity may be detected. The controller 110 may be configured to instruct the UAV to remain in a holding pattern when performance criteria for both communication infrastructures are below a threshold value. The controller 110 may be configured to switch from the satellite communication infrastructure to the wireless communication infrastructure for the UAV whenever the performance criteria for the wireless communication infrastructure exceeds a threshold value. The controller 110 may be configured to track the UAV with radar infrastructure when both communications infrastructure have degraded below a predetermined threshold value. The controller may be configured to evaluate the magnitude of a deviation in actual flight path of a particular UAV from a predetermined flight plan for that UAV and provide corrective instructions to that particular UAV. The controller may be configured to monitor UAV flight paths for potential proximity encroachment and reroute at least one of the UAVs to avoid proximity encroachment. The UAV may be configured to maintain a holding pattern when there may be a loss of connectivity between the UAV and both of the communications infrastructures. The system may be configured to build a library of infrastructure performance against recorded conditions and use that library to predict communications infrastructure degradation along a planned flight path and modify the flight plan to avoid loss of connectivity or communications infrastructure degradation. The system may be configured to monitor weather conditions along a planned flight path and modify the flight plan to avoid loss of connectivity or communications degradation.

In certain aspects of the disclosure, a method includes establishing communication between a UAV and wireless communication infrastructure; establishing communication between the UAV and satellite communication infrastructure; providing a controller that evaluates signal availability, latency and performance for communication between the UAV and the wireless communication infrastructure and between the UAV and the satellite communication infrastructure; tracking and controlling the UAV via the wireless communication infrastructure when a signal may be available from the wireless communication infrastructure and the latency and performance of the wireless signal exceeds a predetermined acceptable threshold; switching to tracking and controlling the UAV via the satellite communication infrastructure when a signal may be not available from the wireless communications infrastructure or the latency or performance of the signal from the wireless communication infrastructure may be below a predetermined threshold; and switching back to tracking and controlling the UAV via the wireless communication infrastructure when a signal may be available and the latency and performance of the signal from the wireless communication infrastructure exceeds the predetermined acceptable threshold.

The present methods and system may be operational with other general purpose or special purpose computing system environments or configuration. Examples of well-known computing systems, environments, and/or configurations that may be suitable for use with the methods and system comprise, but are not limited to, personal computers, server computers, laptop devices, multiprocessor systems, and the like.

The computing device disclosed herein may comprise one or more processors, a system memory, and a bus that couples various components of the computer to the system memory. The computing device may comprise a variety of computer readable media, such as removable and non-removable media. The system memory may comprise computer readable media in the form of volatile memory, such as RAM, and/or non-volatile memory, such as read-only memory. The methods and system may employ artificial intelligence techniques such as machine learning and iterative learning.

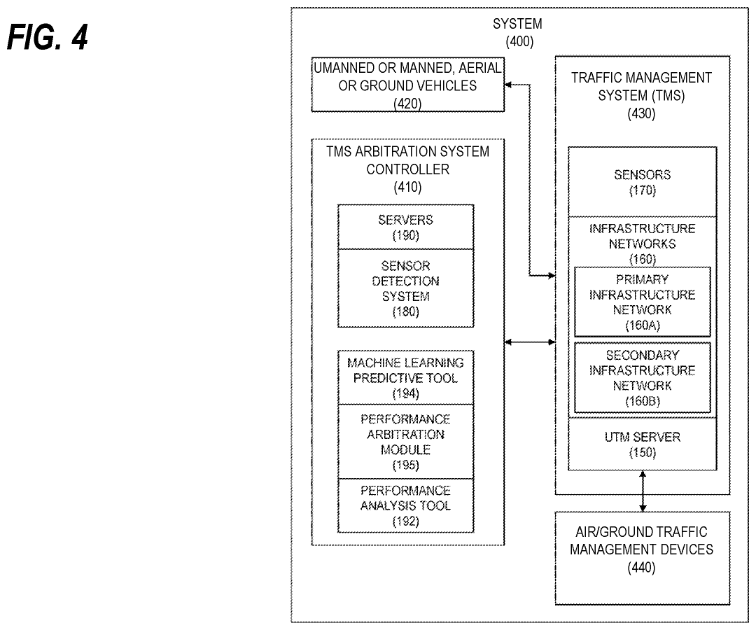

FIG. 4 illustrates a schematic view of an exemplary system 400 for monitoring and arbitrating traffic management infrastructure networks similar to the exemplary system 100 of FIG. 1. The primary differences of system 400 of FIG. 4 include a Traffic Management System (TMS) arbitration system controller 410, in place of the Unmanned Traffic Management (UTM) arbitration system controller 110 of FIG. 1, an unmanned or manned, aerial or ground-based vehicle or system 420 in place of the unmanned aerial systems 120 of FIG. 1, a Traffic Management System (TMS) 430 in place of the Unmanned Traffic Management (UTM) System 130 of FIG. 1, and the air or ground traffic management devices 440 in place of the air traffic management devices 140 of FIG. 1. These aforementioned components allow the system 400 including the TMS 430 and the TMS arbitration system controller 410 to be used with both aerial and ground-based vehicles/systems, whether manned or unmanned/autonomous. All other components of FIG. 4 that have the same reference numbers as FIG. 1 are identical elements in function as previously describe except for use with either aerial and ground-based vehicles/systems, whether manned or unmanned.

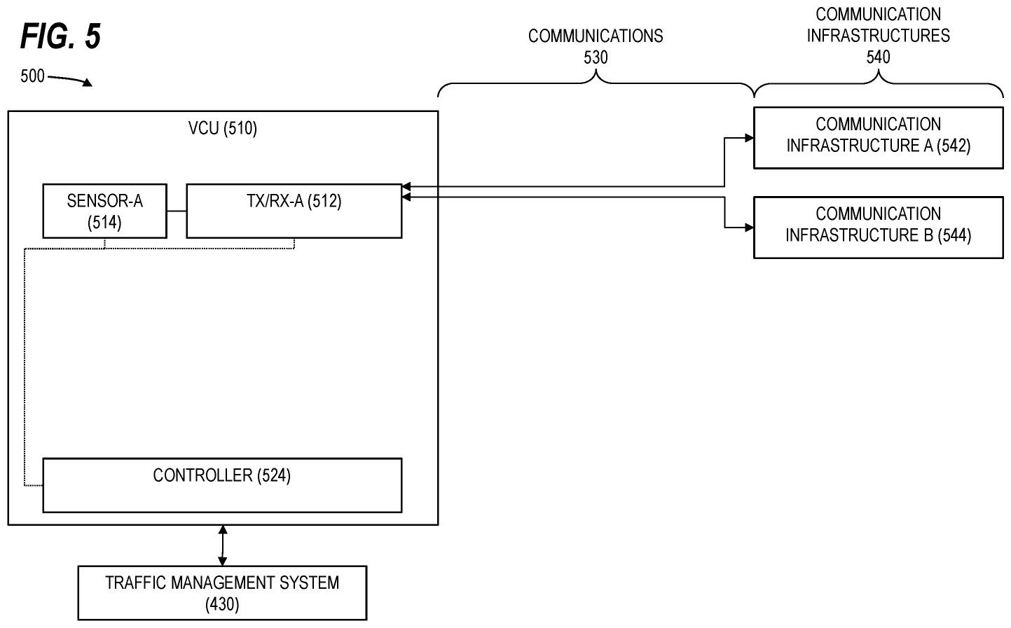

FIG. 5 illustrates a first configuration 500 of a Vehicle Connectivity Unit (VCU) 510 that may be located in a UAS 120, (see FIG. 1), a manned or unmanned aerial vehicle, an autonomous or manned ground-based motor vehicle or unmanned communication node in communication with a traffic management system 430 of FIG. 4 that may include a manned traffic management system 430, or an Unmanned Traffic Management (UTM) System 130 of FIG. 1, or both systems. The VCU 510 may include a single transmitter/receiver 502, (often referred to as a communication transceiver, which may include two separate functional components or a single component with shared circuitry), capable of establishing and maintaining sequential communications 510 between two or more different communications infrastructures 540, e.g., 542 and 544, (e.g., switching between communications infrastructures as needed). A sensor 514 may be provided to frequency scan and sample each of the different communication infrastructures 542 and 544 and provide output to a controller 524 to rapidly evaluate communication performance characteristics substantially continuously and nearly simultaneously to facilitate switching between each of the respective communication infrastructures based on the evaluated communication performance characteristics.

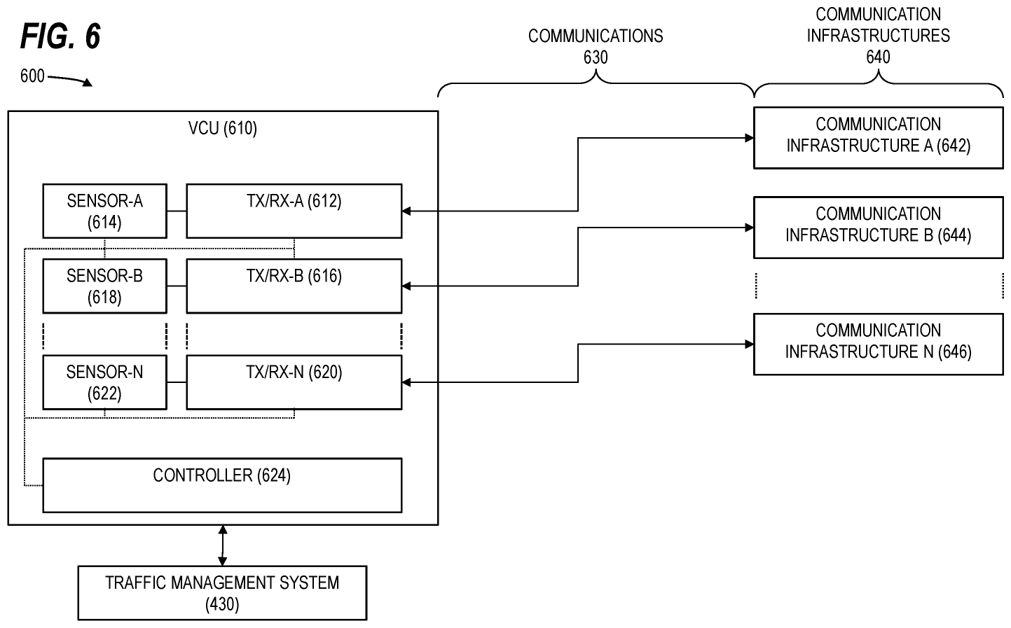

FIG. 6 illustrates an alternative configuration 600 of a Vehicle Connectivity Unit (VCU) 610 that may be located in a UAS 120, (see FIG. 1 a manned or unmanned aerial vehicle, an autonomous or manned ground-based motor vehicle or unmanned communication node in communication with a traffic management system 430 of FIG. 4, or an Unmanned Traffic Management (UTM) System 130 of FIG. 1, or both systems. The VCU 610 may include a plurality of transmitter/receivers 612, 616 and 620 provided in a VCU 610, where each single transmitter/receiver of the plurality of transmitter/receivers may be associated with a respective different communication infrastructure 642, 644 and 646, respectively. Sensors 614, 618 and 622 may be provided to frequency scan and sample each of the different communication infrastructures 642, 644 and 646, respectively, and to provide output to a controller 624 to rapidly evaluate communication performance characteristics substantially continuously and nearly simultaneously to facilitate switching between each of the respective communication infrastructures based on each of the evaluated communication performance characteristics.

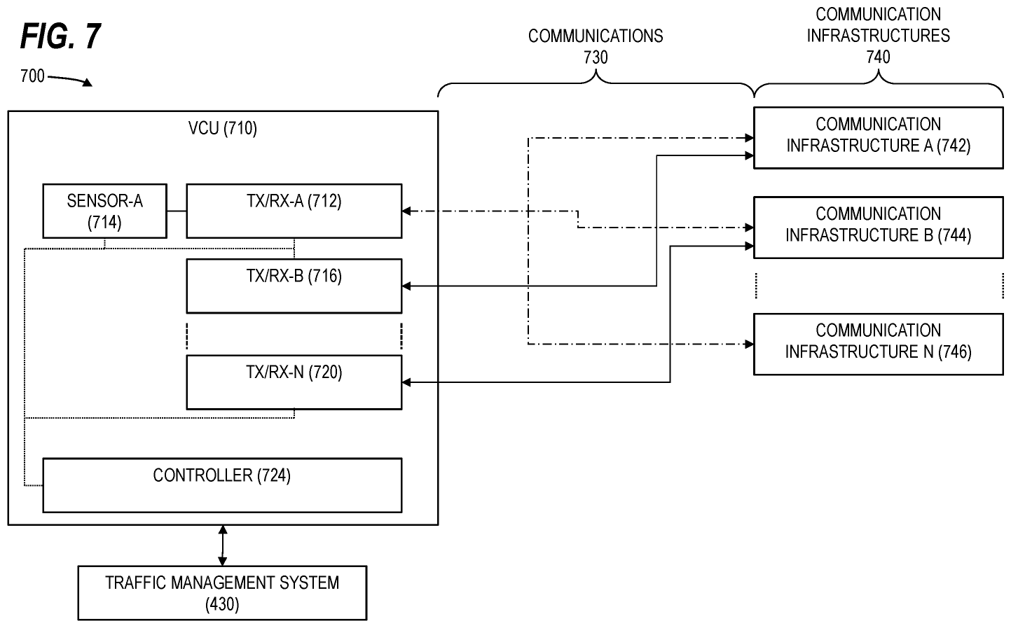

FIG. 7 illustrates a further alternative configuration 700 of a Vehicle Connectivity Unit (VCU) 710 that may be located in a UAS 120, (see FIG. 1), a manned or unmanned aerial vehicle, an autonomous or manned ground-based motor vehicle or unmanned communication node in communication with a traffic management system 430 of FIG. 4, or an Unmanned Traffic Management (UTM) System 130 of FIG. 1, or both systems. The VCU 710 may include a transceiver 712 and sensor 714 combination to be used for monitoring, (represented by the dash-dot-dash communication lines), all frequencies of each of the respective communications infrastructures 742, 744 and 746 for communication performance characteristics, and a second transceiver, (e.g., 716) or group of transceivers, (e.g., 716 and 718) that may be used for active communications, (represented by the solid communication lines), between one or more of the respective communication infrastructures 740 and the VCU 710. For example, transceiver “B” 716 may be in communication with communication infrastructure “A” 742, and transceiver “N” 718 may be in communication with communication infrastructure “N” 744, as illustrated. However, each transceiver “B” 716 and “N” 718 may be switched to any of other communication infrastructures 740 based on evaluated communication performance characteristics.

Sensor 714 may be provided to frequency scan and sample each of the different communication infrastructures 742, 744 and 746 and to provide output to a controller 724 to rapidly evaluate communication performance characteristics substantially continuously and nearly simultaneously to facilitate switching between each of the respective communication infrastructures 740 based on each of the evaluated communication performance characteristics.

The single transceiver 712 may also monitor performance of each of the communications infrastructures 740 and may provide output to the controller 724 to establish active communication with any of the respective communications infrastructures 740 having a best performance characteristics by assigning each monitoring operation by the sensor 714 of the communication infrastructures to predetermined time windows.

An example of a communication infrastructure for use with an unmanned aerial traffic management system, an autonomous ground vehicle traffic management system, or a manned vehicle monitoring system may include a wireless telephone communication system, such as a cellular telephone system that provides a wireless connectivity between a public switched telephone network and users within the radio range of the traffic management system that may include the unmanned traffic management system 130 of FIG. 1.

For certain ground vehicle traffic management/monitoring systems, telecommunications channels may include high frequency (HF), ultrahigh frequency (UHF) and very high frequency (VHF) ranges. For ground vehicle traffic management/monitoring systems, roadside transmitters/receivers may be provided along motorways and highways for to monitor the status, vehicle position and control of autonomous ground vehicles, and monitor the status and vehicle position of manned ground vehicles. As used herein, telecommunications channels refers to radio frequency communications other than wireless telephone communications and satellite telephone communications.

Satellite telephone communications are a preferred secondary communications infrastructure for monitoring and/or controlling unmanned aerial vehicles and may be used as a secondary or tertiary communications infrastructure for other traffic monitoring/control systems, or as a preferred primary traffic monitoring and/or control system for maritime vehicles.

For each of the above examples, at least one sensor, (e.g., 514 of FIG. 5), may be included in the VCU, (e.g., 510 of FIG. 5), to measure and report at least one performance characteristic of communication between the VCU and a traffic management system (e.g., UTM 430 of FIG. 4), for each of the communications infrastructures, (e.g., 540 of FIG. 5). For example, a single signal strength meter may be used for sequentially checking a communication strength level of a signal between a vehicle and a traffic management system for each of a plurality of communications infrastructures (e.g., cellular telephone, satellite telephone, and a VHF frequency telecommunication channel). A sensor array may be provided including a dedicated signal strength indicator (SSI) for each of the communication infrastructures, and/or a dedicated latency detection calculator may be provided for each of the communication infrastructures, such that the status and utility of each available communication infrastructure may be continuously and/or sequentially monitored. Signal strength may be monitored over a period of time to determine whether communications are stable or intermittent (i.e., frequently low strength).

The controller, (e.g., 524, 624 and 724), includes a computer processing unit (CPU) that may be programmed to select a particular communications infrastructure for communications between the traffic management system, (e.g., 430 of FIG. 4), and a vehicle being monitored and/or controlled by the traffic management system based on the measured performance characteristics generated by the sensor(s). Performance thresholds may be established for switching among available communications infrastructures, and for switching to a safe mode when performance characteristics are below acceptable thresholds for all available communications infrastructures.

In the case of aerial traffic management and maritime traffic management, the vehicle may be placed into a holding pattern where it substantially maintains a fixed position and/or adjusts its position to avoid collisions with other vehicles using various LIDAR-based, radar-based or other collision avoidance systems. Such safe modes may include extending distance between vehicles.

The VCU, (e.g., 510 of FIG. 5), may be the communication subsystem enabling a Communication Infrastructure Mesh (CIM) which formulates a new communication infrastructure seamlessly integrating Wireless, SATCOM, Radio, and RADAR communication infrastructure. The CIM may be enabled by a three-tier architecture consisting of space, aerial, and ground segments. The CIM and its VCU/Communication Subsystem may provide the communication infrastructure with an Unmanned Aerial System Traffic Management Performance Arbitration System (UPAS) and Autonomous Vehicle Traffic Management Performance Arbitration System (AVPAS) integrate.

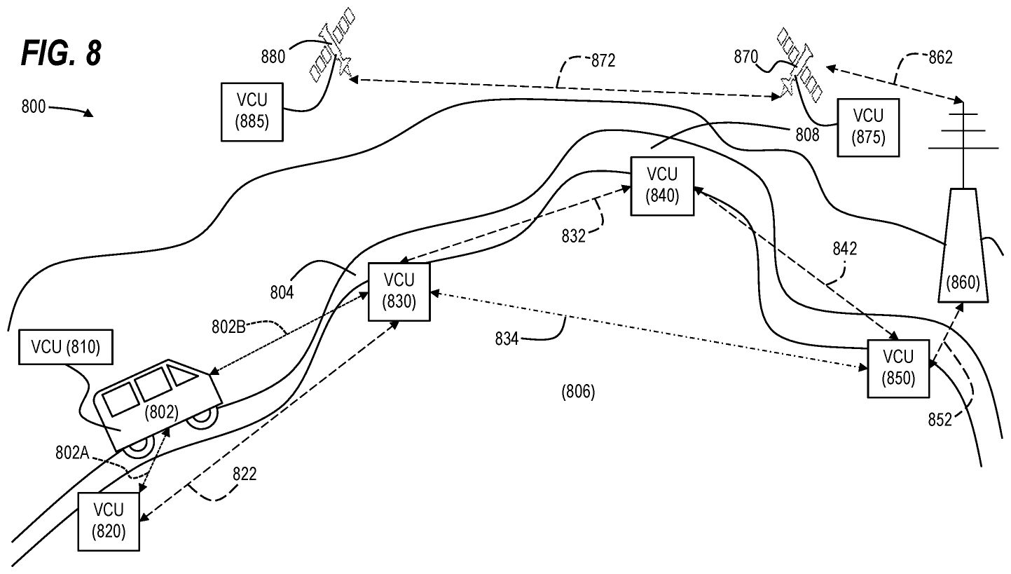

For example, FIG. 8 illustrates an exemplary ground segment 800 of the CIM with a VCU communication subsystem enabled by a VCU 810 enabled ground vehicle 802, (which may be manned or autonomously controlled), traveling along a road 804 that vertically ascends as the ground vehicle travels towards an apex 808 in the road. The vehicle VCU 810 at a first time may initiate communications 802A with a first stationary ground-based VCU 820 based on observed communication performance parameters such as signal strength, and signal latency parameters, as previously discussed. The vehicle VCU 810 at a second time may initiate communications 802B with a second stationary ground-based VCU 830 based on observed communication performance parameters such as signal strength, and signal latency parameters, as previously discussed, for example, when the vehicle approaches the second VCU 830.

Each of the stationary VCUs, (e.g., 820, 830, 840 and 850), may communicate with any and all VCUs, whether adjacent or not adjacent, to relay communications to an intermediate endpoint 860 such as a relay tower that may or may not be a protocol belonging to a different type of communication infrastructure.

However, in the illustration of FIG. 8, the apex 808 of a hill along which the road 804 traverses, prevents line-of-sight relayed communication 834, (illustrated as a dash-dot-dash line), between VCU 830 and VCU 850. In such a configuration, a VCU 840 may be placed proximate the physical apex 808 that would normally prevent such a line-of-sight transmission to complete the transmission chain from VCU 830 to VCU 850 and finally to an intermediate transmission point 860. Thus, communication signals transmitted by the vehicle 802 to any of the VCUs along the road 804 would be relayed, for example, between stationary VCU 820 as relayed transmission signal 822 to VCU 830, then as relayed transmission signal 832 to VCU 840, then as relayed transmission signal 842 to VCU 850, and finally as relayed transmission signal 852 to the intermediate transmission point 860. Optionally, the intermediate transmission point 860 may provide a relayed transmission signal 862 to a non-terrestrial communication node such as satellite 870 having a VCU 875 for receiving and transmitting a relayed transmission signal 872 to a second satellite 880 having a VCU 885. Each of the VCUs 875 and 885 may operate in a similar manner as the VCUs described above that both provide communication and connectivity management between communication nodes within any number of communication infrastructures and between communication nodes of a homogenous communication infrastructure.

This same satellite 870 may operate as a communication node for the vehicular-based VCU 810 as an alternative communication infrastructure to the ground-based infrastructure of stationary nodes 820, 830, 840 and 850 if the vehicular-based VCU 810 determines performance characteristics of the ground-based nodes being below a predetermined threshold, for example, signals strength and/or latency calculations.

In a similar manner, any other transmission signal impediment, similar to the line-of-sight problem of FIG. 8, such as Electromagnetic Interference (EMI) or Radio Frequency Interference (RFI), may be mitigated by strategic placement of VCU devices in stationary positions that may allow manned or unmanned vehicles traveling along aerial or terrestrial paths to stay connected to the CIM and maintain the full functionality of being able to monitor and switch between communication infrastructures while communicating with the Traffic Management System (TMS) and TMS Arbitration System Controller.

The CIM VCU/Communication Subsystem and CIM enabling three tier architecture may provide the following functions:
Monitor CIM signal performance/strength and continuity across SATCOM, wireless communication systems, radio frequencies, and radar communication infrastructures relative to vehicles and devices such as tablets, laptops, phones connectivity (Vehicle-to-Infrastructure);
Monitor CIM signal performance/strength and continuity across SATCOM, wireless, radio, and radar communication infrastructures relative to vehicle-to-vehicle (V2V) connectivity;
Arbitrate between the CIM communication layers, (e.g., SATCOM, wireless, radio, radar), by determining which communication infrastructure layer may be most effective, which layer should be the primary infrastructure at any given time, and dynamically switching between the communication infrastructure layers;
Receive messages, information, data from various sources including but not limited to infrastructure, (communication, sensors such as a VCU operating as a stationary road side communication unit), vehicles (internal to a vehicle such as On Board Diagnostic (OBD) systems as well as between vehicles (V2V)), devices such as tablets, laptops, phones, etc.;
Transmit messages, information, data from various sources including but not limited to infrastructure, (communication, sensors such as a VCU operating as a stationary road side communication unit), vehicles (internal to a vehicle as well as between vehicles, (V2V)), devices such as tablets, laptops, phones, etc.;
Enable integration of data and information, with the UPAS/AVPAS enabling analytic decision capability relative to communication enabling continuous communication and connectivity management with respect to autonomous and manned vehicles; and

The CIM VCU/Communication Subsystem and CIM enabling three tier architecture because of its interface capabilities with devices as described above also provides continuous communication and connectivity management in rural areas where the communication infrastructure has limitations either due to level of maturity, terrain, and environment as well as urban areas which could have constraints such as capacity, interference, and environment, (urban canyons).

For example, FIG. 8 further illustrates two exemplary architectures of the three tier architecture, namely a ground-based stationary VCU mesh network of VCUs 820, 830, 840 and 850, and a satellite-based, (either orbiting or geostationary), mesh network of satellites 870 and 880 configured to communication between each other, (e.g., via relay communication 872), and the ground-based VCU mesh network 870 and 880 via intermediate node 860.

The industries served by this system may include, automotive, communication, utilities, oil and gas, infrastructure, transportation and logistics, agriculture, public safety, and national security.

In summary, a vehicle connectivity and communication device is presented herein that includes at least one transceiver configured to selectively communicate with at least two different communication infrastructures from the group of a wireless cellular communication infrastructure, a radio frequency communication infrastructure, and a satellite communication infrastructure, at least one sensor configured to measure a performance characteristic of each of the selected communication infrastructures and to generate a signal indicative of the measured performance characteristic for each respective selected communication infrastructures, and a controller in communication with the at least one transceiver and the at least one sensor configured to select at least one of the at least two different communication infrastructures and deselect the other of the at least two difference communication infrastructures based on the signal indicative of the measured performance character for each of the respective selected communication infrastructures.

The vehicle connectively device may include the at least one transceiver having a single transceiver configured to communicate with the at least two different communication infrastructures based on the performance characteristics of each of the selected communication infrastructures.

The vehicle connectively device may further include the single transceiver configured to communicate with the at least two different communication infrastructures in discrete sequential time periods to measure the performance character of each of the at least two different communication infrastructures.

The vehicle connectively device may further include the at least one transceiver having a plurality of transceivers configured to communicate with a corresponding plurality of different communication infrastructures based on the performance characteristics of each of the selected communication infrastructures.

The vehicle connectively device may further include the plurality of transceivers configured to communicate with the corresponding plurality of different communication infrastructures to measure the performance character of each of the corresponding plurality of different communication infrastructures.

The vehicle connectively device may further include the at least one sensor having a plurality of sensors corresponding to each of the plurality of transceivers.

The vehicle connectively device may further include the at least one transceiver further having a first transceiver configured to communicate with each of the at least two different communication infrastructures to measure the performance characteristic of each of the at least two communication infrastructures and to generate corresponding signals indicative of the measured performance characteristic for each respective selected communication infrastructures.

The vehicle connectively device may further include the first transceiver configured to communicate with each of the at least two different communication infrastructures in discrete sequential time periods to measure the performance character of each of the at least two different communication infrastructures.

The vehicle connectively device may further include the at least one transceiver further having a plurality of second transceivers configured to communicate with a corresponding plurality of the at least two different communication infrastructures.

The vehicle connectively device may further include the measured performance characteristic of each of the selected communication infrastructures having a strength of signal value.

The vehicle connectively device may further include the measured performance characteristic of each of the selected communication infrastructures having a calculated communication latency value.

The vehicle connectively device may further include the measured performance characteristic of each of the selected communication infrastructures having an observed communication signal continuity value.

The vehicle connectively device may further include the controller configured to select a secondary communications infrastructure as an active communications channel when a minimum threshold for the performance characteristic of a primary communication infrastructure are not within a predetermined range.

The vehicle connectively device may further include the at least two different communication infrastructures being at least one from the group of a land-based communication infrastructure, an aerial-based communication infrastructure and a space-based communication infrastructure.

The vehicle connectively device may further include the controller configured to output an operating instruction to a vehicle in which the vehicle connectively unit operates therein when the controller determines a measured performance characteristic for at least one of the selected communication infrastructures falls below a predetermined operating threshold.

The vehicle connectively device may further include the controller configured to output a safe mode operating instruction to the vehicle when the controller determines the measured performance characteristic for at least two of the selected communication infrastructures falls below the predetermined operating threshold.

The vehicle connectively device may further include the safe mode operating instruction modifying a vehicle-to-vehicle collision avoidance distance parameter.

The vehicle connectively device may further include the controller configured to output a change of travel path operating instruction to the vehicle when the controller determines the measured performance characteristic for at least two of the selected communication infrastructures falls below the predetermined operating threshold.

An alternative vehicle connectivity and communication device presented herein includes at least one transceiver configured to selectively communicate with at least two different communication infrastructures having different communication protocols and selected from the group of a land-based communication infrastructure, an aerial-based communication infrastructure and a space-based communication infrastructure, at least one sensor configured to measure a performance characteristic of each of the selected communication infrastructures and to generate a signal indicative of the measured performance characteristic for each respective selected communication infrastructures, and a controller in communication with the at least one transceiver and the at least one sensor configured to select at least one of the at least two different communication infrastructures and deselect the other of the at least two difference communication infrastructures based on the signal indicative of the measured performance character for each of the respective selected communication infrastructures.

An alternative vehicle connectivity and communication device presented herein includes at least one transceiver configured to selectively communicate with at least two different communication infrastructures having different communication protocols, at least one sensor configured to measure a performance characteristic of each of the selected communication infrastructures and to generate a signal indicative of at least one of a strength of signal value, a calculated communication latency value, and an observed communication signal continuity value for each respective selected communication infrastructures, and a controller in communication with the at least one transceiver and the at least one sensor configured to select at least one of the at least two different communication infrastructures and deselect the other of the at least two difference communication infrastructures based on the signal indicative of the measured performance character for each of the respective selected communication infrastructures.

It is to be understood that the various embodiments described in this specification and as illustrated in the attached drawings are simply exemplary embodiments illustrating the inventive concepts as defined in the claims. As a result, it is to be understood that the various embodiments described and illustrated may be combined to form the inventive concepts defined in the appended claims.

The foregoing description, for purpose of explanation, has been described with reference to specific arrangements and configurations. However, the illustrative examples provided herein are not intended to be exhaustive or to limit embodiments of the disclosed subject matter to the precise forms disclosed. Many modifications and variations are possible in view of the disclosure provided herein. The embodiments and arrangements were chosen and described in order to explain the principles of embodiments of the disclosed subject matter and their practical applications. Various modifications may be used without departing from the scope or content of the disclosure and claims presented herein.

What is claimed is:

1. A vehicle connectivity and communication device comprising:
at least one transceiver configured to selectively communicate with at least two different communication infrastructures from the group of a wireless cellular communication infrastructure, a radio frequency communication infrastructure, and a satellite communication infrastructure;
at least one sensor configured to measure a performance characteristic of each of the selected communication infrastructures and to generate a signal indicative of the measured performance characteristic for each respective selected communication infrastructures; and
a controller in communication with the at least one transceiver and the at least one sensor configured to select at least one of the at least two different communication infrastructures and deselect the other of the at least two difference communication infrastructures based on the signal indicative of the measured performance character for each of the respective selected communication infrastructures.

2. The vehicle connectively device according to claim 1, wherein the at least one transceiver comprises a single transceiver configured to communicate with the at least two different communication infrastructures based on the performance characteristics of each of the selected communication infrastructures.

3. The vehicle connectively device according to claim 2, wherein the single transceiver is configured to communicate with the at least two different communication infrastructures in discrete sequential time periods to measure the performance character of each of the at least two different communication infrastructures.

4. The vehicle connectively device according to claim 1, wherein the at least one transceiver comprises a plurality of transceivers configured to communicate with a corresponding plurality of different communication infrastructures based on the performance characteristics of each of the selected communication infrastructures.

5. The vehicle connectively device according to claim 4, wherein the plurality of transceivers are configured to communicate with the corresponding plurality of different communication infrastructures to measure the performance character of each of the corresponding plurality of different communication infrastructures.

6. The vehicle connectively device according to claim 4, wherein the at least one sensor comprises a plurality of sensors corresponding to each of the plurality of transceivers.

7. The vehicle connectively device according to claim 1, wherein the at least one transceiver further comprises a first transceiver configured to communicate with each of the at least two different communication infrastructures to measure the performance characteristic of each of the at least two communication infrastructures and to generate corresponding signals indicative of the measured performance characteristic for each respective selected communication infrastructures.

8. The vehicle connectively device according to claim 7, wherein the first transceiver is configured to communicate with each of the at least two different communication infrastructures in discrete sequential time periods to measure the performance character of each of the at least two different communication infrastructures.

9. The vehicle connectively device according to claim 7, wherein the at least one transceiver further comprises a plurality of second transceivers configured to communicate with a corresponding plurality of the at least two different communication infrastructures.

10. The vehicle connectively device according to claim 1, wherein the measured performance characteristic of each of the selected communication infrastructures includes a strength of signal value.

11. The vehicle connectively device according to claim 1, wherein the measured performance characteristic of each of the selected communication infrastructures includes a calculated communication latency value.

12. The vehicle connectively device according to claim 1, wherein the measured performance characteristic of each of the selected communication infrastructures includes an observed communication signal continuity value.

13. The vehicle connectively device according to claim 1, wherein the controller is configured to select a secondary communications infrastructure as an active communications channel when a minimum threshold for the performance characteristic of a primary communication infrastructure are not within a predetermined range.

14. The vehicle connectively device according to claim 1, wherein the at least two different communication infrastructures are at least one from the group of a land-based communication infrastructure, an aerial-based communication infrastructure and a space-based communication infrastructure.

15. The vehicle connectively device according to claim 1, wherein the controller is configured to output an operating instruction to a vehicle in which the vehicle connectively unit operates therein when the controller determines a measured performance characteristic for at least one of the selected communication infrastructures falls below a predetermined operating threshold.

16. The vehicle connectively device according to claim 15, wherein the controller is configured to output a safe mode operating instruction to the vehicle when the controller determines the measured performance characteristic for at least two of the selected communication infrastructures falls below the predetermined operating threshold.

17. The vehicle connectively device according to claim 16, wherein the safe mode operating instruction modifies a vehicle-to-vehicle collision avoidance distance parameter.

18. The vehicle connectively device according to claim 15, wherein the controller is configured to output a change of travel path operating instruction to the vehicle when the controller determines the measured performance characteristic for at least two of the selected communication infrastructures falls below the predetermined operating threshold.

19. A vehicle connectivity and communication device comprising:
at least one transceiver configured to selectively communicate with at least two different communication infrastructures having different communication protocols and selected from the group of a land-based communication infrastructure, an aerial-based communication infrastructure and a space-based communication infrastructure;
at least one sensor configured to measure a performance characteristic of each of the selected communication infrastructures and to generate a signal indicative of the measured performance characteristic for each respective selected communication infrastructures; and
a controller in communication with the at least one transceiver and the at least one sensor configured to select at least one of the at least two different communication infrastructures and deselect the other of the at least two difference communication infrastructures based on the signal indicative of the measured performance character for each of the respective selected communication infrastructures.

20. A vehicle connectivity and communication device comprising:
at least one transceiver configured to selectively communicate with at least two different communication infrastructures having different communication protocols;
at least one sensor configured to measure a performance characteristic of each of the selected communication infrastructures and to generate a signal indicative of at least one of a strength of signal value, a calculated communication latency value, and an observed communication signal continuity value for each respective selected communication infrastructures; and
a controller in communication with the at least one transceiver and the at least one sensor configured to select at least one of the at least two different communication infrastructures and deselect the other of the at least two difference communication infrastructures based on the signal indicative of the measured performance character for each of the respective selected communication infrastructures.
